(19) United States
(12) Patent Application Publication
(10) Pub. No.: US 2010/0073738 A1
(43) Pub. Date: Mar. 25, 2010

(54) IMAGE PROCESSING APPARATUS AND IMAGE COPY METHOD

(75) Inventor: I-Yueh Chi, Taichung City (TW)

Correspondence Address: COVENANT IP CONSULTING CO., P.O. BOX 34-306 TAIPEI CITY, TAIPEI, 10499, TW

(73) Assignee: AVISION INC., Hsinchu (TW)

(21) Appl. No.: 12/554,963

(22) Filed: Sep. 7, 2009

(30) Foreign Application Priority Data
Sep. 22, 2008 (TW) 97136372

(51) Int. Cl. H04N 1/04

(52) U.S. Cl. 358/474

(57) ABSTRACT

An image processing apparatus and an image copy method are provided. The image processing apparatus includes a housing, a scanning module and a processing unit. The processing unit is for controlling the scanning module to perform a scanning process. The scanning process includes the steps of scanning module to respectively to scan two pages located in a scanning window of the housing from a start-scanning position to an end-scanning position so as to generate two images. The distance from the start-scanning position to the end-scanning position at most equals a half of a length of the scanning window. The processing unit is further used for combining the two images. The image copy method further includes the steps of respectively scanning the two pages to obtain the two images and combining the two images into a combined image.

### IMAGE PROCESSING APPARATUS AND IMAGE COPY METHOD

This application claims the benefit of Taiwan application Serial No. 97136372, filed Sep. 22, 2008, the subject matter of which is incorporated herein by reference.

### BACKGROUND OF THE INVENTION

1. Field of the Invention

The invention relates in general to an image processing apparatus and an image copy method, and more particularly to an image processing apparatus and an image copy method capable of combining images.

2. Description of the Related Art

Currently, image processing apparatus, such as multi-function peripheral (MFP), plays an important role in household or office use. The image processing apparatus is provided for scanning the image of documents and further displaying or storing the scanned image of the documents in the format of an electronic file. In addition, the image processing apparatus is further provided for printing, faxing or emailing the electronic file so as to facilitate the transmission and processing of the documents.

The application of the image processing apparatus includes combining images of the documents. After two different documents or the front page and the rear page of the same document are respectively scanned, the two scanned images are combined into a combined image. Normally, when the image processing apparatus performs the scanning process for combining the scanned images, a scanning module of the image processing apparatus scans the document according to an ordinary scanning process. That is, the scanning module scans the document from one end of the scanning window and stops scanning at the other end of the scanning window so as to capture the image within the whole scanning window. The size of the image approximately equals the scanning window. Next, the two images obtained by scanning the document(s) are combined. However, according to the above way of capturing images, the two images approximately equaling the size of the scanning window must be reduced first, so that the two images can be juxtaposed with each other on the same page. As all the scanned images are reduced the size, the images may be blurred or distorted. Particularly, in the application of combining the images of a small-sized document, for example an ID card, the information in the image may be hard to recognize as the size of the printed image is too small.

### SUMMARY OF THE INVENTION

The invention is directed to an image processing apparatus and an image copy method. A first page and a second page of a document are captured at most equal a half of a length of a scanning window to respectively generate a first image and a second image. The first page and the second page are placed at a position of the scanning window, where a to-be-scanned document is normally placed, to improve the operation convenience. In addition, by way of combining the first image and the second image, the scanned images of several to-be-scanned pages can be integrated to form a single image.

According to an aspect of the present invention, an image processing apparatus is provided. The image processing apparatus includes a housing, a scanning module and a processing unit. The scanning module is disposed in the housing. The housing has a scanning window. The processing unit coupled to the scanning module is used for controlling the scanning module to perform a scanning process. The scanning process includes using the scanning module to scan a first page located in the scanning window from a start-scanning position, and to stop scanning the first page at an end-scanning position to generate a first image corresponding to the first page, and to scan a second page located in the scanning window from the start-scanning position and to stop scanning the second page at the end-scanning position to generate a second image corresponding to the second page. The distance from the start-scanning position to the end-scanning position at most equals a half of a length of the scanning window. The processing unit is further used for combining the first image and the second image into a combined image.

According to another aspect of the present invention, an image copy method is provided. The image copy method used in an image processing apparatus includes a scanning module for scanning a document. The image copy method includes the following steps. Firstly, a first page located in a scanning window of the image processing apparatus is scanned from a start-scanning position to an end-scanning position, wherein the distance from the start-scanning position to the end-scanning position at most equals a half of the length of the scanning window. Then, scanning the first page stops at the end-scanning position and a first image corresponding to the first page is generated. In addition, the scanning module is moved to the start-scanning position. Afterwards, a second page located in the scanning window is scanned from the start-scanning position to the end-scanning position. Then, scanning the second page stops at the end-scanning position and a second image corresponding to the second page is generated. After that, the first image and the second image are combined into a combined image.

The invention will become apparent from the following detailed description of the preferred but non-limiting embodiments. The following description is made with reference to the accompanying drawings.

### BRIEF DESCRIPTION OF THE DRAWINGS

FIG. 1 shows a diagram of an example of an image processing apparatus;

FIG. 2 shows a diagram of another example of an image processing apparatus;

FIG. 3 shows a functional block diagram of the image processing apparatus;

FIG. 4 shows a flowchart of an image copy method according to a preferred embodiment of the present invention;

FIG. 5 shows a first page located in a scanning window;

FIG. 6 shows a second page located in a scanning window;

FIG. 7 shows a path diagram of a scanning module when performing the scanning process;

FIG. 8 shows another path diagram of a scanning module when performing the scanning process; and

FIG. 9 shows a combined image of a first image and a second image.

### DETAILED DESCRIPTION OF THE INVENTION

The present invention will be apparent from the following detailed description, which proceeds with reference to the accompanying drawings, wherein the same references relate to the same elements.

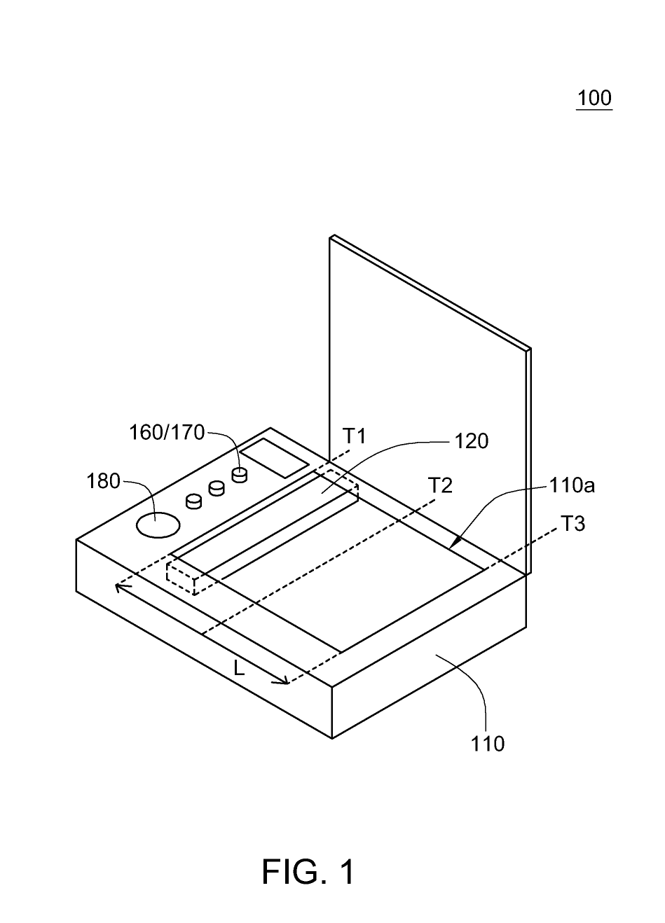

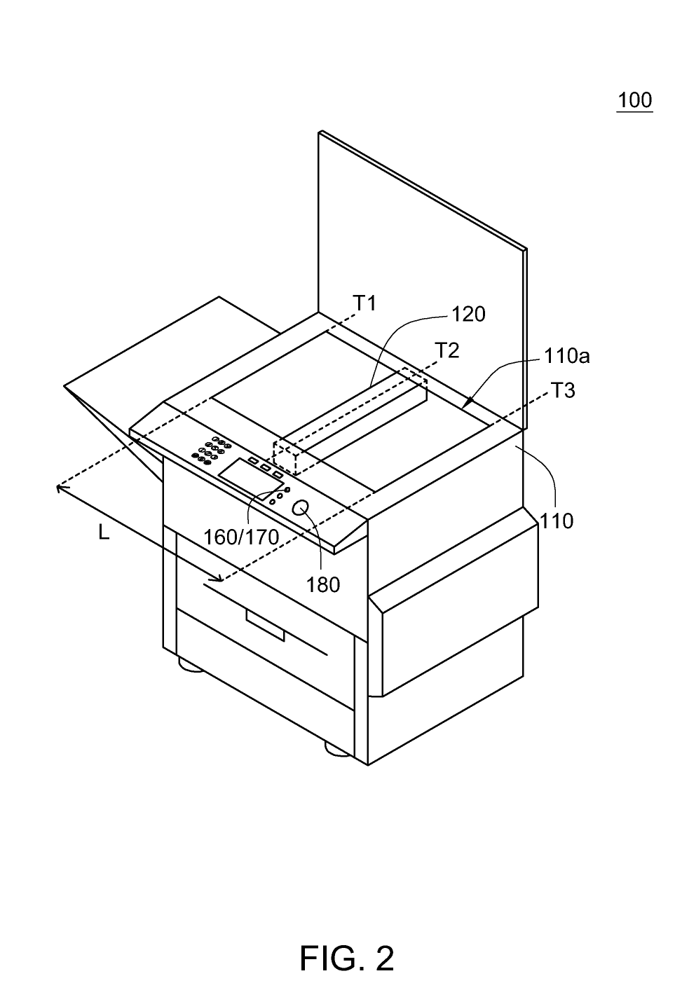

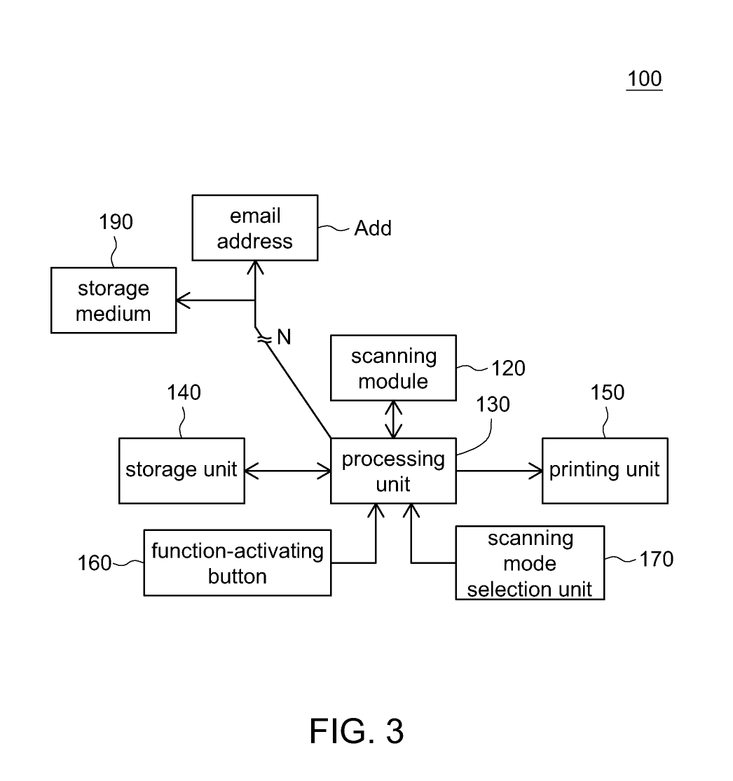

An image processing apparatus according to a preferred embodiment of the present invention is elaborated. Referring to FIG. 1 to FIG. 3 at the same time, a diagram of an example of an image processing apparatus is shown in FIG. 1, a diagram of another example of an image processing apparatus is shown in FIG. 2, and a functional block diagram of the image processing apparatus is shown in FIG. 3. In the present embodiment of the invention, the image processing apparatus 100 can be, for example, a flatbed scanner as illustrated in FIG. 1, and can also be other image apparatus, for example, a multi-function peripheral (MFP) as illustrated in FIG. 2. The image processing apparatus 100 includes a housing 110 and a scanning module 120. The housing 110 has a scanning window 110a. The scanning module 120 is movably disposed in the housing 110. Referring to FIG. 3, the image processing apparatus 100 further includes a processing unit 130 which is coupled to the scanning module 120 and used for controlling the scanning module 120 to perform a scanning process. The scanning process includes the following steps. Firstly, the scanning module 120 scans a first page located in the scanning window 110a from a start-scanning position T1 and stops scanning at an end-scanning position T2 to generate a first image, and scans a second page located in the scanning window 110a from the start-scanning position T1 and stops scanning at the end-scanning position T2 to generate a second image. The distance from the start-scanning position T1 to the end-scanning position T2 at most equals a half of a length L of the scanning window 110a. In addition, the processing unit 130 is further used for combining the first image and the second image into a combined image, and the combination process will be disclosed below.

The image processing apparatus 100 further includes a storage unit 140. The storage unit 140 coupled to the processing unit 130 is used for storing the first image, the second image, and the combined image. The processing unit 130 can email the combined image stored in the storage unit 140 to an email address Add through a network N (such as an intranet or an Internet). Moreover, the image processing apparatus 100 further includes a printing unit 150 for printing the combined image on the same page of paper. Alternatively, the image processing apparatus 100 further includes a function-activating button 160 and a scanning mode selection unit 170. The function-activating button 160 can be disposed on the housing 110 and coupled to the processing unit 130. The function-activating button 160 is used for activating the above-mentioned scanning process. When the function-activating button 160 is pressed, the scanning module 120 immediately performs the scanning process. The scanning mode selection unit 170 coupled to the processing unit 130 is used for providing several scan modes for users. The scan modes include a scan mode corresponding to the above-mentioned scanning process. After a user selects the scan mode, the user needs to further press the function-activating button 160, so that the scanning module 120 performs the above-mentioned scanning process.

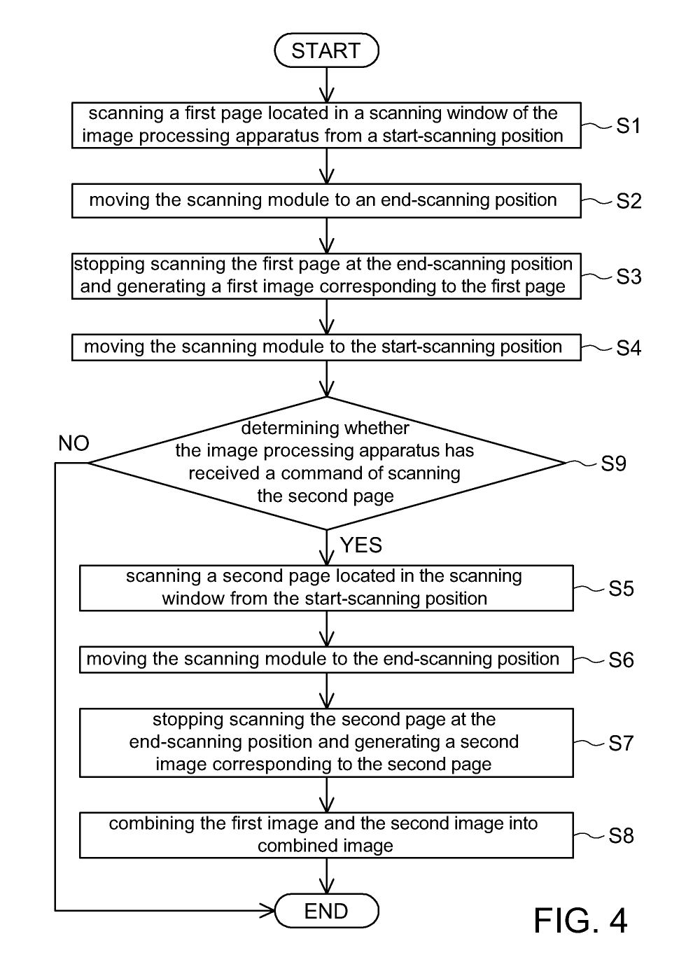

The image copy method according to a preferred embodiment of the present invention is disclosed below. The image copy method is used in an image processing apparatus which is preferably the image processing apparatus 100 (as illustrated in FIG. 1). Referring to FIG. 4 to FIG. 7 and FIG. 9, a flowchart and related diagrams of an image copy method according to a preferred embodiment of the present invention is shown.

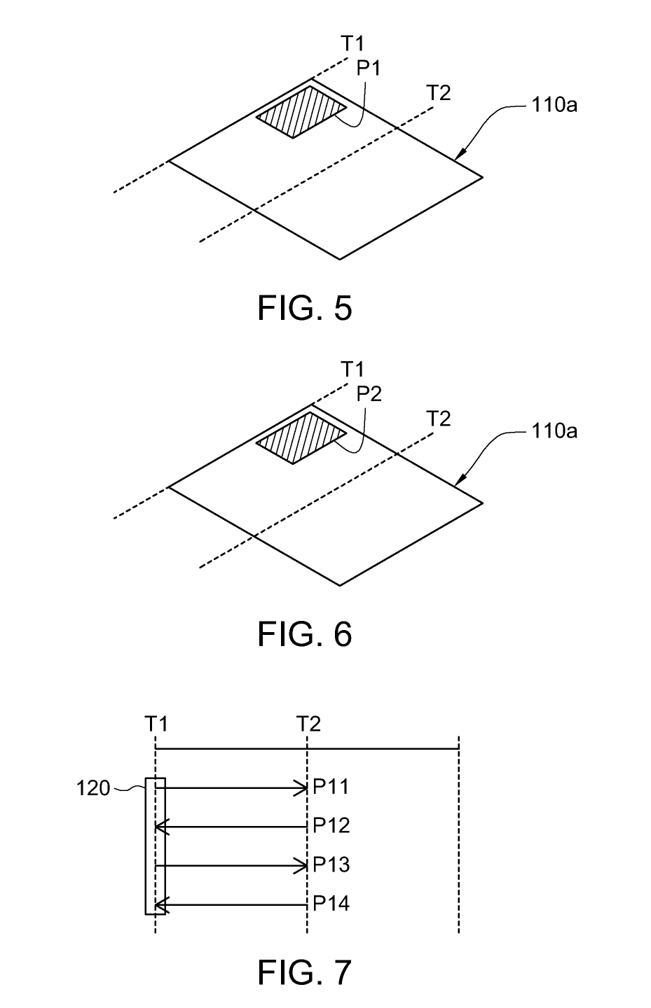

As indicated in the steps S1˜S3 in FIG. 4, the scanning module 120 scans a first page P1 located in the scanning window 110a from a start-scanning position T1 illustrated in FIG. 5 and stops scanning at an end-scanning position T2 to generate a first image M1 corresponding to the first page P1. In the present embodiment of the invention, the start-scanning position T1 is located at one end of the scanning window 110a and the first page P1 is preferably placed between the start-scanning position T1 and the end-scanning position T2. Referring to FIG. 7, a path diagram of the scanning module 120 when performing the scanning process is shown. In practical application, after the step S3 is completed, the scanning module 120 stops at the end-scanning position T2 as illustrated by the path P11.

Next, in the step S4 in FIG. 4, the scanning module 120 is moved to the start-scanning position T1 as illustrated by the path P12 in FIG. 7 so as to be ready to scan the second page P2 or the next document.

In the steps S5˜S7 in FIG. 4, the scanning module 120 scans the second page P2 from the start-scanning position T1. Referring to FIG. 6, the second page P2 is preferably placed at the position between the start-scanning position T1 and the end-scanning position T2 of the scanning window 110a as illustrated in FIG. 6. When the scanning module 120 is moved to the end-scanning position T2, the scanning module 120 stops scanning and generates a second image M2 by the path P13 in FIG. 7. In practical application, after the step S7 is completed, the scanning module 120 stops moving at the end-scanning position T2.

In addition, the image copy method further comprises a step S9 for determining whether a command of scanning the second page P2 is received as illustrated in FIG. 4. If the command is received, the steps S5˜S8 will be performed.

In the present embodiment of the invention, in the image copy method in FIG. 4, the image copy method can further include the step of immediately moving the scanning module 120 back to the start-scanning position T1 as illustrated by the path P14 in FIG. 7 to facilitate subsequent scanning.

In addition, the first page P1 and the second page P2 can be the front page and the rear page of the same document or belong to different documents. As the size of each of the first page P1 and the second page P2 at most equal the half of the length L of the scanning window 110a, or the range of a to-be-captured image of document(s) at most equal the half of the length L of the scanning window 110a even when the size of the document is larger than the half of the length L of the scanning window 110a, the scanning module 120 can completely scan the first page P1 and the second page P2 by moving between the start-scanning position T1 and the end-scanning position T2. Therefore, the scan time can be saved and the efficiency can be increased.

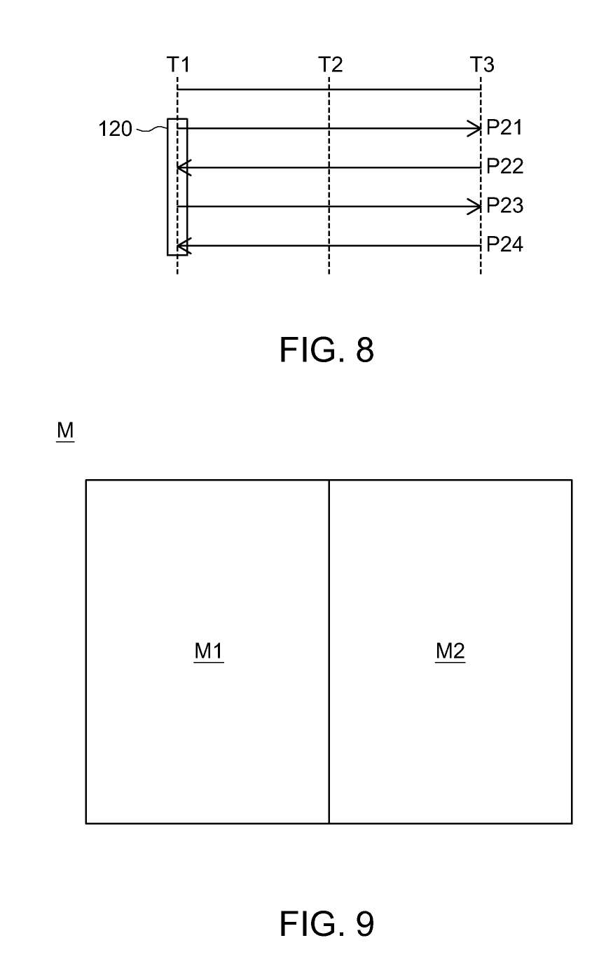

In the steps S1˜S3 in FIG. 4, the scanning module 120 scans the first page P1 from the start-scanning position T1 and stops scanning the first page P1 at the end-scanning position T2. In addition, in the steps S5˜S7 in FIG. 4, the scanning module 120 scans the second page P2 from the start-scanning position T1 and stops scanning the second page P2 at the end-scanning position T2. That is, during the scanning process, the scanning module 120 stops at the end-scanning position T2 as illustrated in FIG. 7. However, the movement of the scanning module 120 according to the present embodiment of the invention is not limited thereto. Referring to FIG. 8, the first page P1 and the second page P2 are respectively placed at the position of the scanning window 110a. During the operation of scanning the first page P1 placed in the scanning window 110a from the start-scanning position T1 and stopping scanning the first page P1 at the end-scanning position T2, the scanning module 120 passes through the end-scanning position T2 and is moved to stop at a movement-end position T3 illustrated by the path P21. Afterwards, the scanning module 120 is moved back to the start-scanning position T1 illustrated by the path P22. During the operation of scanning the second page P2 placed in the scanning window 110a from the start-scanning position T1 and stopping scanning the second page P2 at the end-scanning position T2, the scanning module 120 passes through the end-scanning position T2 and is moved to stop at the movement-end position T3 illustrated by the path P23. Afterwards, the scanning module 120 is moved back to the start-scanning position T1 illustrated by the path P24. The distance from the start-scanning position T1 to the movement-end position T3 at least equals a half of the length L of the scanning window 110a. That is, every time after the scanning module 120 stops scanning at the end-scanning position T2, the scanning module 120 keeps being moved to the movement-end position T3, and the scanning module 120 does not perform scanning when the scanning module 120 is moved to the movement-end position T3 from the end-scanning position T2. In the present embodiment of the invention, for example, the movement-end position T3 is located at the other end of the scanning window 110a opposite to the start-scanning position T1 as illustrated in FIG. 1.

Thus, after the first image and the second image are obtained by using the method in FIG. 4, the method proceeds to the step S8 to combine the first image M1 with the second image M2. Referring to FIG. 9, a combined image M of a first image M1 and a second image M2 is shown. In the present embodiment of the invention, each of the path P11 and the path P13 illustrated in FIG. 7 at most equal a half of the length L of the scanning window 110a. Thus, the processing unit 130 of the image processing apparatus 100 can combine the first image M1 and the second image M2 into the combined image M with an equal ratio, and the combined image M is stored in the storage unit 140. The length of the combined image M at most equals the length L of the scanning window 110a.

In the present embodiment of the invention, referring to FIG. 3, the combined image M can be emailed to an email address Add through a network N (such as an intranet or an Internet), printed through the printing unit 150, or transmitted to a storage medium 190 through the network N. As the length of the combined image M at most equals the length L of the scanning window 110a, the combined image M can be printed on the same page of paper with an equal ratio without being enlarged or reduced first. Also, the first image M1 and the second image M2 can be combined with different ratios by the processing unit 130 of the image processing apparatus 100 to fit the user's individual needs. For example, the processing unit 130 can enlarge/reduce the image of the first image M1, the second image M2 or both of them firstly and then combine the enlarged/reduced image of the first image M1 and/or the second image M2 into the combined image M.

In practical application, before the command of scanning the second page P2 of the step S9 is received by the image processing apparatus 100, the image processing apparatus 100 can directly email the first image M1 to an email address Add, or output the first image M1. For example, the first image M1 is printed on paper by the printing unit 150, or is transmitted to the storage medium 190 through a network, wherein the storage medium 190 is, for example, a network server. After the image processing apparatus 100 receives the command of scanning the second page P2, the image processing apparatus 100 performs the step of scanning the second page P2 located in the scanning window 110a, that is, the step S5 in FIG. 5.

According to the image processing apparatus and the image copy method of a preferred embodiment of the present invention, the scanning module scans between the start-scanning position and the end-scanning position, and the distance from the start-scanning position to the end-scanning position at most equals a half of the length of the scanning window. Thus, when combining two images of the front page and the rear page of a small-sized document (such as an ID card or a driver license), the sizes of the two images do not need to be adjusted, so that the combined image can be printed on the same page of paper with an equal ratio, hence avoiding image distortion. Moreover, when the image copy method is used, the first page and the second page are placed at the position of the scanning window as in an ordinary scanning process, so that the process of combining images is convenient. In addition, according to the image copy method of the embodiment of the present invention, the scanning process can be activated by pressing the function-activating button of the image processing apparatus or by selecting the scanning process of the scanning mode selection unit and then pressing the start button.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image processing apparatus, comprising:
a housing having a scanning window;
a scanning module movably disposed in the housing for scanning a document; and
a processing unit, coupled to the scanning module, used for controlling the scanning module to perform a scanning process, wherein the scanning process comprises:
the scanning module to scan a first page located in the scanning window from a start-scanning position and to stop scanning the first page at an end-scanning position to generate a first image corresponding to the first page, and to scan a second page located in the scanning window from the start-scanning position and to stop scanning the second page at the end-scanning position to generate a second image corresponding to the second page;
wherein the distance from the start-scanning position to the end-scanning position at most equals a half of a length of the scanning window;
wherein the processing unit is further used for combining the first image and the second image into a combined image.

2. The image processing apparatus according to claim 1, wherein the start-scanning position is located at an end of the scanning window.

3. The image processing apparatus according to claim 1, further comprising:
a storage unit, coupled to the processing unit, used for storing the first image, the second image, and the combined image.

4. The image processing apparatus according to claim 1, further comprising:
a printing unit, coupled to the processing unit, used for printing the combined image on the same page of paper.

5. The image processing apparatus according to claim 1, wherein the processing unit further emails the combined image to an email address.

6. The image processing apparatus according to claim 1, wherein the processing unit further transmits the combined image to a storage medium through a network;
wherein, the network is an intranet or an Internet.

7. The image processing apparatus according to claim 1, further comprising:
a function-activating button, disposed on the housing, for activating the scanning process.

8. The image processing apparatus according to claim 1, further comprising:
a scanning mode selection unit, coupled to the processing unit, for receiving a user command and transmitting the user command to the processing unit, wherein the processing unit controls the scanning module to perform the scanning process according to the user command.

9. The image processing apparatus according to claim 1, wherein the processing unit combines the first image and the second image with an equal ratio.

10. The image processing apparatus according to claim 1, wherein the processing unit combines the first image and the second image with different ratios.

11. The image processing apparatus according to claim 1, wherein the first page and the second page are the front page and the rear page of the same document.

12. An image copy method used in an image processing apparatus comprising a scanning module for scanning a document, wherein the method comprises:
scanning a first page located in a scanning window of the image processing apparatus from a start-scanning position to an end-scanning position; wherein the distance from the start-scanning position to the end-scanning position at most equals a half of a length of the scanning window;
stopping scanning the first page at the end-scanning position;
generating a first image corresponding to the first page;
moving the scanning module to the start-scanning position;
scanning a second page located in the scanning window from the start-scanning position to the end-scanning position;
stopping scanning the second page at the end-scanning position;
generating a second image corresponding to the second page; and
combining the first image and the second image into a combined image.

13. The image copy method according to claim 12, further comprising:
moving the scanning module from the end-scanning position to a movement-end position;
wherein, the distance from the start-scanning position to the movement-end position at least equals a half of the length of the scanning window.

14. The image copy method according to claim 13, wherein the step of moving the scanning module to the start-scanning position comprises:
moving the scanning module to the start-scanning position from the movement-end position.

15. The image copy method according to claim 12, wherein the step of combining the first image and the second image comprises:
combining the first image and the second image with an equal ratio.

16. The image copy method according to claim 12, wherein the step of combining the first image and the second image comprises:
combining the first image and the second image with different ratios.

17. The image copy method according to claim 12, further comprising:
printing the combined image on the same page of paper.

18. The image copy method according to claim 12, further comprising:
emailing the combined image to an email address.

19. The image copy method according to claim 12, further comprising:
transmitting the combined image to a storage medium through a network;
wherein, the network is an intranet or an Internet.

20. The image copy method according to claim 12, wherein before the step of scanning the second page, the method further comprises:
receiving a command of scanning the second page and performing the step of scanning the second page located in the scanning window from the start-scanning position according to the command.
